(19) United States
(12) Patent Application Publication
(10) Pub. No.: US 2012/0019511 A1
(43) Pub. Date: Jan. 26, 2012

(54) SYSTEM AND METHOD FOR REAL-TIME SURGERY VISUALIZATION

(76) Inventor: BALA S. CHANDRASEKHAR, Arcadia, CA (US)

(21) Appl. No.: 12/841,007

(22) Filed: Jul. 21, 2010

(51) Int. Cl. G06T 15/00; H04N 13/02

(52) U.S. Cl. 345/419; 348/46; 348/E13.074

(57) ABSTRACT

A system for providing real-time surgery visualization to achieve symmetric results is provided. The system includes at least one imaging device configured to capture at least one image of a first area of a subject during a surgical procedure. The system further includes at least one projector configured to project at least one reflected image onto a second area of the subject located across an axis of symmetry of the subject from the first area of the subject. The at least one reflected image is reflected with respect to the axis of symmetry and the first area of the subject.

### BACKGROUND OF THE INVENTION

1. Field of the Invention

Embodiments of the invention described herein pertain to the field of computer systems. More particularly, but not by way of limitation, one or more embodiments of the invention enable systems and methods for providing real-time surgery visualization to achieve symmetric results.

2. Description of the Related Art

The body plans of most multicellular organisms exhibit some form of symmetry. Most animals are bilateral asymmetric, including humans. In a bilaterally symmetric organism, the sagittal plane divides the organism into two halves with roughly mirror image external appearance.

Symmetry is associated with attractiveness. Some researchers theorize that this association is based on natural selection. Symmetry is also considered an indicator for genetic health, as both environmental and genetic factors play an important role in proper embryonic development. Although bilateral symmetry is most strongly exhibited externally, many internal anatomical features, such as bones, nerves, muscles, and the circulatory system, also display some bilateral symmetry, especially in extremities.

When a surgical procedure is performed, symmetry is often a desired result. This is especially true in the case of plastic surgery. Plastic surgery includes reconstructive surgery, hand surgery, microsurgery, burn treatment, as well as cosmetic surgery. Even though symmetry is a desired result, limited systems and methods have been developed to achieve symmetry. Plastic surgeons often rely on experience, skill, and pre-surgery analysis of images and models taken before surgery. Often, when both of two symmetric areas undergo surgical procedures, the surgery is performed over multiple sessions, in part to allow for additional analysis.

Current surgical devices are capable of providing a stereoscopic view of an area during surgery, such as microsurgery. Stereoscopic images of the area are displayed on a screen. During surgery, a user views the surgery through special eyepieces which allow a stereoscopic view of the screen as well as a direct view of the operating area. Stereoscopic images are often generated using two cameras mounted with a slightly different point of view to replicate the natural stereoscopic view.

However, there are currently no known systems that provide systems and methods for providing real-time surgery visualization to achieve symmetric results.

### BRIEF SUMMARY OF THE INVENTION

One or more embodiments of the invention enable systems and methods for providing real-time surgery visualization to achieve symmetric results. At least one image of a first area of a subject is taken in real-time during a surgical procedure. The image is reflected with respect to the axis of symmetry of the subject. The reflected image is projected onto a second area of the subject in real-time during the surgical procedure.

One or more embodiments described herein include a system for providing real-time surgery visualization to achieve symmetric results including at least one three-dimensional imaging device, at least one projector, and a computer.

The at least one three-dimensional imaging device is configured to capture at least one three-dimensional image of a first area of a subject during a surgical procedure.

The at least one projector configured to project at least one reflected image onto a second area of the subject located across an axis of symmetry of the subject from the first area of the subject, where the at least one reflected image is reflected with respect to the axis of symmetry and the first area of the subject.

The computer includes at least one processor and a computer-readable medium encoded with instructions, where execution of the instructions causes the at least one processor to execute process steps including processing the at least one three-dimensional image to obtain the at least one reflected image.

In one or more embodiments of the system for providing real-time surgery visualization, the at least one three-dimensional imaging device includes a bicameral stereoscopic imaging device.

In one or more embodiments of the system for providing real-time surgery visualization, the at least one three-dimensional imaging device includes a first area scanner configured to obtain three-dimensional surface information of the first area of the subject, and execution of the instructions causes the at least one processor to execute process steps further including producing the at least one three-dimensional image from the three-dimensional surface information.

One or more embodiments of the system for providing real-time surgery visualization further include a second area scanner configured to obtain projection surface information of the second area of the subject in three dimensions, and execution of the instructions causes the at least one processor to execute process steps further including processing the at least one reflected image to modify the at least one reflected image to account for the projection surface information before projection onto the second area of the subject.

In one or more embodiments of the system for providing real-time surgery visualization, execution of the instructions causes the at least one processor to execute process steps further including using image processing to determine at least one image enhancement, and modifying the at least one reflected image to include the at least one image enhancement.

In one or more embodiments of the system for providing real-time surgery visualization, the axis of symmetry is a bilateral axis of symmetry of the subject.

In one or more embodiments of the system for providing real-time surgery visualization, the at least one three-dimensional image includes a plurality of three-dimensional images at multiple time points, and the at least one reflected image is projected in real-time by projecting at least one updated reflected image using the projector at the multiple time points.

In one or more embodiments of the system for providing real-time surgery visualization, execution of the instructions causes the at least one processor to execute process steps further including obtaining projection surface information of the second area of the subject, selecting at least one alignment feature common to the first area of the subject and the second area of the subject, determining at least one first area image feature corresponding to the at least one alignment feature in the at least one three-dimensional image of the first area of the subject, determining at least one second area surface feature corresponding to the at least one alignment feature in the second area of the subject using the projection surface information of the second area of the subject, and registering the at least one reflected image and the second area of the subject based on the at least one first area image feature and the at least one second area surface feature.

In one or more embodiments of the system for providing real-time surgery visualization, the surgical procedure is a plastic surgery procedure. The surgical procedure may include at least one of a breast image enhancement procedure and a breast reconstruction procedure, where the first area is a first breast of the subject and the second area is a second breast of the subject.

One or more embodiments described herein include a method for providing real-time surgery visualization to achieve symmetric results. The method includes obtaining at least one three-dimensional image of a first area of a subject during a surgical procedure from at least one three-dimensional imaging device, aligning a projector with a second area of the subject, where the second area of the subject is located across an axis of symmetry of the subject from the first area of the subject, processing the at least one three-dimensional image to obtain at least one reflected image of the at least one three-dimensional image, where the at least one reflected image is reflected with respect to the axis of symmetry, and stereoscopically projecting the at least one reflected image onto the second area of the subject using the projector.

In one or more embodiments of the method for providing real-time surgery visualization, the at least one three-dimensional imaging device includes a bicameral stereoscopic imaging device.

In one or more embodiments of the method for providing real-time surgery visualization, the at least one three-dimensional imaging device includes a first area scanner configured to obtain three-dimensional surface information of the first area of the subject, and the method further includes producing the at least one three-dimensional image from the three-dimensional surface information.

One or more embodiments of the method for providing real-time surgery visualization further include obtaining a scan of the second area of the subject including projection surface information for the second area of the subject in three dimensions using a second area scanner, and processing the at least one reflected image using at least one computational device to modify the at least one reflected image to account for the projection surface information for projection onto the second area of the subject.

In one or more embodiments of the method for providing real-time surgery visualization, the processing includes image processing using at least one computational device to produce the at least one reflected image.

One or more embodiments of the method for providing real-time surgery visualization further include using image processing to determine at least one image enhancement, and modifying the at least one reflected image to include the at least one image enhancement.

In one or more embodiments of the method for providing real-time surgery visualization, the processing includes optically manipulating the three-dimensional image to obtain the at least one reflected image.

In one or more embodiments of the method for providing real-time surgery visualization, the axis of symmetry is a bilateral axis of symmetry of the subject.

In one or more embodiments of the method for providing real-time surgery visualization, the at least one three-dimensional image includes a plurality of three-dimensional images at multiple time points, where the at least one reflected image is projected in real-time by projecting at least one updated reflected image using the projector at the multiple time points.

One or more embodiments of the method for providing real-time surgery visualization further include obtaining projection surface information with respect to the second area of the subject, selecting at least one alignment feature common to the first area of the subject and the second area of the subject, determining at least one first area image feature corresponding to the at least one alignment feature in the at least one three-dimensional image of the first area of the subject, determining at least one second area surface feature corresponding to the at least one alignment feature in the second area of the subject using the projection surface information of the second area of the subject, and registering the at least one reflected image and the second area of the subject based on the at least one first area image feature and the at least one second area surface feature.

In one or more embodiments of the method for providing real-time surgery visualization, the surgical procedure is a plastic surgery procedure. The surgical procedure may include at least one of a breast image enhancement procedure and a breast reconstruction procedure, where the first area is a first breast of the subject and the second area is a second breast of the subject.

One or more embodiments described herein include a system for providing real-time surgery visualization to achieve symmetric results, the system including a YZ imaging device, a YZ projecting device, and a computer.

The YZ imaging device is configured to capture a YZ image of a first area of a subject during a surgical procedure, where the YZ imaging device is configured to face a YZ capture orientation approximately perpendicular to a YZ plane of the first area of the subject.

The YZ projecting device is configured to project a reflected YZ image of the subject onto a second area of the subject during the surgical procedure, where the YZ projecting device is configured to face a YZ projection orientation approximately perpendicular to the YZ plane, where the YZ capture orientation is about 180 degrees from the YZ projection orientation.

The computer includes one or more processors and a computer-readable medium encoded with instructions, where execution of the instructions causes the one or more processors to execute process steps including generating the reflected YZ image based on the YZ image, and registering the reflected YZ image with the second area of the subject, where the second area of the subject is located across an axis of symmetry of the subject from the first area of the subject.

In one or more embodiments of the system for providing real-time surgery visualization, the axis of symmetry is a bilateral axis of symmetry of the subject.

In one or more embodiments of the system for providing real-time surgery visualization, execution of the instructions causes the at least one processor to execute process steps further including using image processing to determine at least one image enhancement, and modifying the reflected YZ image to include at the least one image enhancement.

One or more embodiments of the method for providing real-time surgery visualization further include an XY imaging device and an XY projecting device. The XY imaging device is configured to capture an XY image of the first area of the subject during the surgical procedure, where the XY imaging device is configured to face an XY capture orientation approximately perpendicular to an XY plane of the first area of the subject. The XY projecting device is configured to project a reflected XY image of the subject onto the second area of the subject during the surgical procedure, where the XY projecting device is configured to face an XY projection orientation approximately perpendicular to the XY plane, where the XY capture orientation is about parallel to the XY projection orientation. Execution of the instructions causes the at least one processor to execute process steps further including generating the reflected XY image based on the XY image and registering the reflected XY image with the second area of the subject.

In one or more embodiments of the system for providing real-time surgery visualization, execution of the instructions causes the at least one processor to execute process steps further including obtaining a scan of the second area of the subject including projection surface information for the second area of the subject in three dimensions, and processing the reflected YZ image to modify the reflected YZ image before projection onto the second area to account for the projection surface information.

In one or more embodiments of the system for providing real-time surgery visualization, the surgical procedure is a plastic surgery procedure. The surgical procedure may include at least one of a breast image enhancement procedure and a breast reconstruction procedure, where the first area is a first breast of the subject and the second area is a second breast of the subject.

One or more embodiments described herein include a method for providing real-time surgery visualization to achieve symmetric results. The method includes obtaining a YZ image of a first area of a subject during a surgical procedure from a YZ imaging device, where the YZ imaging device is facing a YZ capture orientation approximately perpendicular to a YZ plane of the first area of the subject, generating a reflected YZ image based on the YZ image, registering the reflected YZ image with a second area of the subject, where the second area of the subject is located across an axis of symmetry of the subject from the first area of the subject, and projecting the reflected YZ image of the subject onto the second area of the subject during the surgical procedure with a YZ projecting device, where the YZ projecting device is configured to face a YZ projection orientation approximately perpendicular to the YZ plane, and where the YZ capture orientation is about 180 degrees from the YZ projection orientation.

In one or more embodiments of the method for providing real-time surgery visualization, the axis of symmetry is a bilateral axis of symmetry of the subject.

One or more embodiments of the method for providing real-time surgery visualization further include using image processing to determine at least one image enhancement, and modifying the reflected YZ image to include at the least one image enhancement.

One or more embodiments of the method for providing real-time surgery visualization further include obtaining an XY image of the subject from an XY imaging device, where the XY imaging device is facing an XY capture orientation approximately perpendicular to an XY plane of the first area of the subject, generating a reflected XY image based on the XY image, registering the reflected XY image with the second area of the subject, and projecting the reflected XY image of the subject onto the second area of the subject with a XY projecting device, where the XY projecting device is configured to face a XY projection orientation approximately perpendicular to the XY plane, where the XY capture orientation is about parallel to the XY projection orientation.

One or more embodiments of the method for providing real-time surgery visualization further include obtaining a scan of the second area of the subject including projection surface information for the second area of the subject in three dimensions, and processing the reflected YZ image using at least one computational device to modify the reflected YZ image before projection onto the second area to account for the projection surface information.

In one or more embodiments of the method for providing real-time surgery visualization, the surgical procedure is a plastic surgery procedure. The surgical procedure may include at least one of a breast image enhancement procedure and a breast reconstruction procedure, where the first area is a first breast of the subject and the second area is a second breast of the subject.

One or more embodiments described herein include a system for providing real-time surgery visualization to achieve symmetric results, the system including at least one three-dimensional imaging device, a display, at least one three-dimensional video capture device and a computer.

The at least one three-dimensional imaging device is configured to capture at least one three-dimensional image of a first area of a subject during a surgical procedure.

The display is configured to display three-dimensional video.

The at least one three-dimensional video capture device is configured to capture a live video feed of a second area of the subject using during the surgical procedure, where the second area of the subject is positioned across an axis of symmetry of the subject with respect to the first area of the subject.

The computer includes at least one processor and a computer-readable medium encoded with instructions, where execution of the instructions causes the at least one processor to execute process steps including processing the at least one three-dimensional image to obtain at least one reflected image of the at least one three-dimensional image, where the at least one reflected image is reflected with respect to the axis of symmetry and the first area of the subject, generating an augmented video feed including the live video feed and data from the at least one reflected image, and displaying the augmented video feed on the display, where the augmented video feed is stereoscopically viewable by at least one participant of the surgery in real time.

In one or more embodiments of the system for providing real-time surgery visualization, the display includes at least one projector and a projection surface, where the at least one projector is configured to stereoscopically project the augmented video feed onto the projection surface.

In one or more embodiments of the system for providing real-time surgery visualization, the three-dimensional imaging device includes a three-dimensional optical scanner configured to obtain three-dimensional surface information of the first area of the subject, where execution of the instructions causes the at least one processor to execute process steps further including producing the at least one three-dimensional image from the three-dimensional surface information.

In one or more embodiments of the system for providing real-time surgery visualization, execution of the instructions causes the at least one processor to execute process steps further including using image processing to determine at least one image enhancement, and modifying the augmented video feed to include the at least one image enhancement.

In one or more embodiments of the system for providing real-time surgery visualization, the axis of symmetry is a bilateral axis of symmetry of the subject.

In one or more embodiments of the system for providing real-time surgery visualization, the at least one three-dimensional image includes a plurality of three-dimensional images at multiple time points, where execution of the instructions causes the at least one processor to execute process steps further including updating the augmented video feed based on at least one most recent three-dimensional image.

In one or more embodiments of the system for providing real-time surgery visualization, execution of the instructions causes the at least one processor to execute process steps further including selecting at least one alignment feature common to the first area of the subject and the second area of the subject, determining at least one first area image feature corresponding to the at least one alignment feature in the at least one three-dimensional image of the first area of the subject, and determining at least one second area surface feature corresponding to the at least one alignment feature in the live video feed, where generating the augmented video feed includes registering the at least one reflected image and the live video feed based on the at least one first area image feature and the at least one second area surface feature.

In one or more embodiments of the system for providing real-time surgery visualization, the surgical procedure is a plastic surgery procedure. The surgical procedure may include at least one of a breast image enhancement procedure and a breast reconstruction procedure, where the first area is a first breast of the subject and the second area is a second breast of the subject.

One or more embodiments described herein include a method for providing real-time surgery visualization to achieve symmetric results. The method includes obtaining at least one three-dimensional image of a first area of a subject during a surgical procedure from at least one three-dimensional imaging device, obtaining a live video feed of a second area of the subject using at least one three-dimensional video capture device during the surgical procedure, where the second area of the subject is positioned across an axis of symmetry of the subject with respect to the first area of the subject, processing the at least one three-dimensional image to obtain at least one reflected image of the at least one three-dimensional image, where the at least one reflected image is reflected with respect to the axis of symmetry and the first area of the subject, generating an augmented video feed including the live video feed and data from the at least one reflected image, and displaying the augmented video feed on a display, where the augmented video feed is stereoscopically viewable by at least one participant of the surgery in real time.

In one or more embodiments of the method for providing real-time surgery visualization, the display includes a projection surface, where the augmented video feed is stereoscopically projected onto the projection surface using at least one projector.

In one or more embodiments of the method for providing real-time surgery visualization, the three-dimensional imaging device includes a three-dimensional optical scanner configured to obtain three-dimensional surface information of the first area of the subject, where the method further includes producing the at least one three-dimensional image from the three-dimensional surface information.

In one or more embodiments of the method for providing real-time surgery visualization, the processing includes image processing using at least one computational device to produce the at least one reflected image.

One or more embodiments of the method for providing real-time surgery visualization further include using image processing to determine at least one image enhancement, where the augmented video feed includes the at least one image enhancement.

In one or more embodiments of the method for providing real-time surgery visualization, the axis of symmetry is a bilateral axis of symmetry of the subject.

In one or more embodiments of the method for providing real-time surgery visualization, the at least one three-dimensional image includes a plurality of three-dimensional images at multiple time points, where the augmented video feed is updated based on at least one most recent three-dimensional image.

One or more embodiments of the method for providing real-time surgery visualization further include selecting at least one alignment feature common to the first area of the subject and the second area of the subject, determining at least one first area image feature corresponding to the at least one alignment feature in the at least one three-dimensional image of the first area of the subject, and determining at least one second area surface feature corresponding to the at least one alignment feature in the live video feed, where generating the augmented video feed includes registering the at least one reflected image and the live video feed based on the at least one first area image feature and the at least one second area surface feature.

In one or more embodiments of the method for providing real-time surgery visualization, the surgical procedure is a plastic surgery procedure. The surgical procedure may include at least one of a breast image enhancement procedure and a breast reconstruction procedure, where the first area is a first breast of the subject and the second area is a second breast of the subject.

### BRIEF DESCRIPTION OF THE DRAWINGS

The above and other aspects, features and advantages of the invention will be more apparent from the following more particular description thereof, presented in conjunction with the following drawings wherein:

FIG. 1 illustrates a general-purpose computer and peripherals that when programmed as described herein may operate as a specially programmed computer capable of implementing one or more methods, apparatus and/or systems of the solution.

FIGS. 2A-2C illustrate exemplary subject areas suitable for surgical procedures compatible with systems and methods for providing real-time surgery visualization to achieve symmetric results.

FIG. 3 illustrates an exemplary system in accordance with systems and methods for providing real-time surgery visualization to achieve symmetric results.

FIG. 4 illustrates an exemplary system in accordance with systems and methods for providing real-time surgery visualization to achieve symmetric results.

FIG. 5 illustrates an exemplary system in accordance with systems and methods for providing real-time surgery visualization to achieve symmetric results.

FIG. 6 illustrates an exemplary method in accordance with systems and methods for providing real-time surgery visualization to achieve symmetric results.

FIG. 7 illustrates an exemplary method in accordance with systems and methods for providing real-time surgery visualization to achieve symmetric results.

FIG. 8 illustrates an exemplary method in accordance with systems and methods for providing real-time surgery visualization to achieve symmetric results.

FIG. 9 illustrates three-dimensional surface information in accordance with systems and methods for providing real-time surgery visualization to achieve symmetric results.

FIGS. 10A-10B illustrate an exemplary XY projection and YZ projection in accordance with systems and methods for providing real-time surgery visualization to achieve symmetric results.

FIG. 11 illustrates exemplary image enhancements in accordance with systems and methods for providing real-time surgery visualization to achieve symmetric results.

FIGS. 12A-B illustrate exemplary registration of a reflected image and a second area of a subject in accordance with systems and methods for providing real-time surgery visualization to achieve symmetric results.

FIG. 13 illustrates an adjustable surgical table in accordance with systems and methods for providing real-time surgery visualization to achieve symmetric results.

FIGS. 14A-D illustrate top and side views of an area of a subject lying on an adjustable surgical table in different positions in accordance with systems and methods for providing real-time surgery visualization to achieve symmetric results.

### DETAILED DESCRIPTION

Systems and methods for providing real-time surgery visualization to achieve symmetric results will now be described. In the following exemplary description numerous specific details are set forth in order to provide a more thorough understanding of embodiments of the invention. It will be apparent, however, to an artisan of ordinary skill that the present invention may be practiced without incorporating all aspects of the specific details described herein. In other instances, specific features, quantities, or measurements well known to those of ordinary skill in the art have not been described in detail so as not to obscure the invention. Readers should note that although examples of the invention are set forth herein, the claims, and the full scope of any equivalents, are what define the metes and bounds of the invention.

As used herein, the term “axis of symmetry” refers to any axis or plane where a first area of a subject and a second area of the subject are approximately mirror images with respect to the axis of symmetry. In a three-dimensional space, the axis of symmetry is a plane. In a two-dimensional image, the axis of symmetry is a line.

As used herein, the term “bilateral axis of symmetry” refers to the sagittal plane of the subject, any line in the sagittal plane in three-dimensional space, or any line representing either of the above in a two-dimensional image.

As used herein, the term “surgical procedure” refers to any medical procedure. Systems and methods for providing real-time surgery visualization to achieve symmetric results are compatible with any surgical procedure capable of altering the physical appearance of an external feature, including but not limited to a plastic surgery procedure.

As used herein, the term “plastic surgery” refers to any medical operation concerned with the correction of form and/or function, including but not limited to burn surgery, cosmetic surgery, craniofacial surgery, hand surgery, micro surgery, and pediatric cosmetic surgery.

Numerous plastic surgery procedures are suitable for use with systems and methods for providing real-time surgery visualization to achieve symmetric results, including but not limited to abdominoplasty, blepharoplasty, permanent makeup application, face lifts, breast reduction, breast lift, liposuction, buttock augmentation, buttock lift, labiaplasty, lip enhancement, rhinoplasty, otoplasty, brow lifts, cheek lifts, chin augmentation, cheek augmentation, any other cosmetic implant, filler injections, or any other surgical procedure traditionally considered plastic surgery and/or a cosmetic procedure.

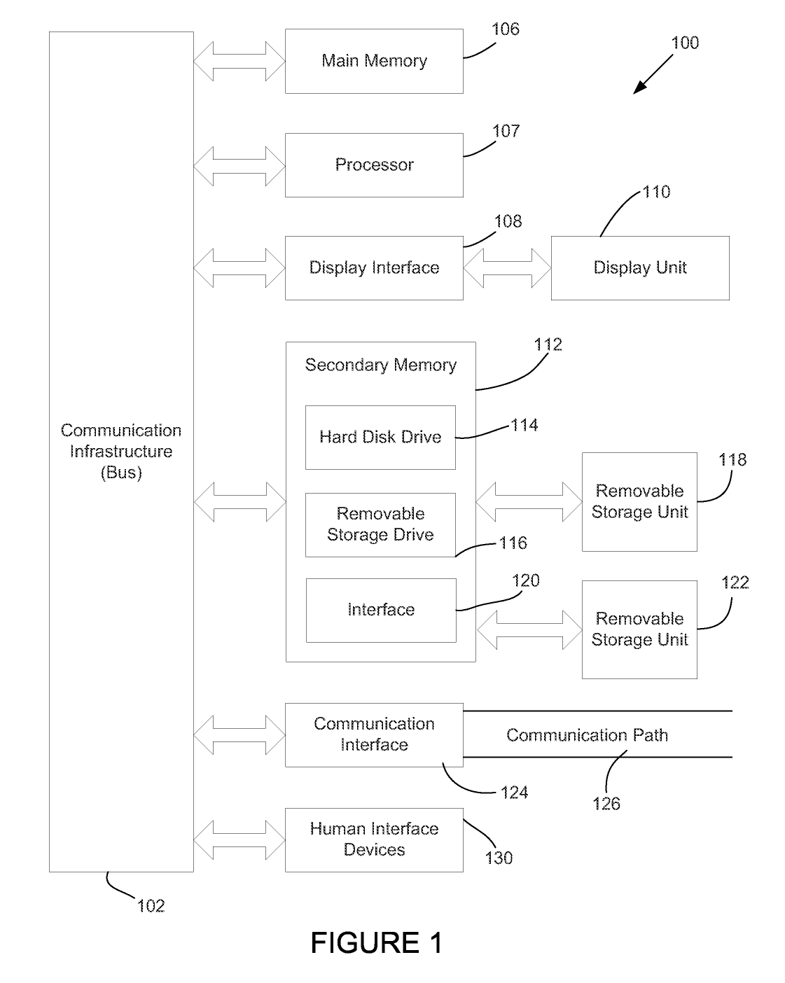

FIG. 1 diagrams a general-purpose computer and peripherals, when programmed as described herein, may operate as a specially programmed computer capable of implementing one or more methods, apparatus and/or systems of the solution described in this disclosure. Processor 107 may be coupled to bi-directional communication infrastructure 102 such as communication infrastructure system bus 102. Communication infrastructure 102 may generally be a system bus that provides an interface to the other components in the general-purpose computer system such as processor 107, main memory 106, display interface 108, secondary memory 112 and/or communication interface 124.

Main memory 106 may provide a computer readable medium for accessing and executed stored data and applications. Display interface 108 may communicate with display unit 110 that may be utilized to display outputs to the user of the specially-programmed computer system. Display unit 110 may include one or more monitors that may visually depict aspects of the computer program to the user. Main memory 106 and display interface 108 may be coupled to communication infrastructure 102, which may serve as the interface point to secondary memory 112 and communication interface 124. Secondary memory 112 may provide additional memory resources beyond main memory 106, and may generally function as a storage location for computer programs to be executed by processor 107. Either fixed or removable computer-readable media may serve as Secondary memory 112. Secondary memory 112 may include, for example, hard disk 114 and removable storage drive 116 that may have an associated removable storage unit 118. There may be multiple sources of secondary memory 112 and systems implementing the solutions described in this disclosure may be configured as needed to support the data storage requirements of the user and the methods described herein. Secondary memory 112 may also include interface 120 that serves as an interface point to additional storage such as removable storage unit 122. Numerous types of data storage devices may serve as repositories for data utilized by the specially programmed computer system. For example, magnetic, optical or magnetic-optical storage systems, or any other available mass storage technology that provides a repository for digital information may be used.

Communication interface 124 may be coupled to communication infrastructure 102 and may serve as a conduit for data destined for or received from communication path 126. A network interface card (NIC) is an example of the type of device that once coupled to communication infrastructure 102 may provide a mechanism for transporting data to communication path 126. Computer networks such Local Area Networks (LAN), Wide Area Networks (WAN), Wireless networks, optical networks, distributed networks, the Internet or any combination thereof are some examples of the type of communication paths that may be utilized by the specially program computer system. Communication path 126 may include any type of telecommunication network or interconnection fabric that can transport data to and from communication interface 124.

To facilitate user interaction with the specially programmed computer system, one or more human interface devices (HID) 130 may be provided. Some examples of HIDs that enable users to input commands or data to the specially programmed computer may include a keyboard, mouse, touch screen devices, microphones or other audio interface devices, motion sensors or the like, as well as any other device able to accept any kind of human input and in turn communicate that input to processor 107 to trigger one or more responses from the specially programmed computer are within the scope of the system disclosed herein.

While FIG. 1 depicts a physical device, the scope of the system may also encompass a virtual device, virtual machine or simulator embodied in one or more computer programs executing on a computer or computer system and acting or providing a computer system environment compatible with the methods and processes of this disclosure. Where a virtual machine, process, device or otherwise performs substantially similarly to that of a physical computer system, such a virtual platform will also fall within the scope of disclosure provided herein, notwithstanding the description herein of a physical system such as that in FIG. 1.

One or more embodiments are configured to enable the specially programmed computer to take the input data given and transform it into a web-based UI by applying one or more of the methods and/or processes described herein. Thus the methods described herein are able to transform a stored component into a web UI, using the solution disclosed here to result in an output of the system as a web UI design support tool, using the specially programmed computer as described herein.

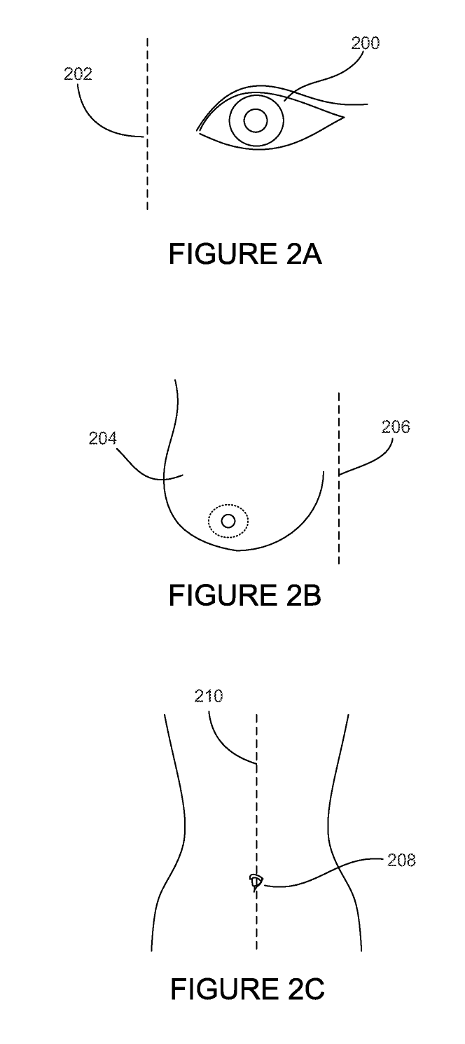

FIGS. 2A-2C illustrate exemplary subject areas compatible with systems and methods for providing real-time surgery visualization to achieve symmetric results. FIG. 2A shows a facial feature 200 of a subject and the corresponding axis of symmetry 202. FIG. 2B shows a breast 204 of a subject and the corresponding axis of symmetry 206. FIG. 2C shows an intersecting feature 208 of a subject that intersects the corresponding axis of symmetry 210.

Any feature of a subject with a corresponding symmetric feature across an axis of symmetry is compatible with systems and methods for providing real-time surgery visualization to achieve symmetric results. Additionally, any symmetric anatomical feature with an axis of symmetry is compatible with systems and methods for providing real-time surgery visualization to achieve symmetric results.

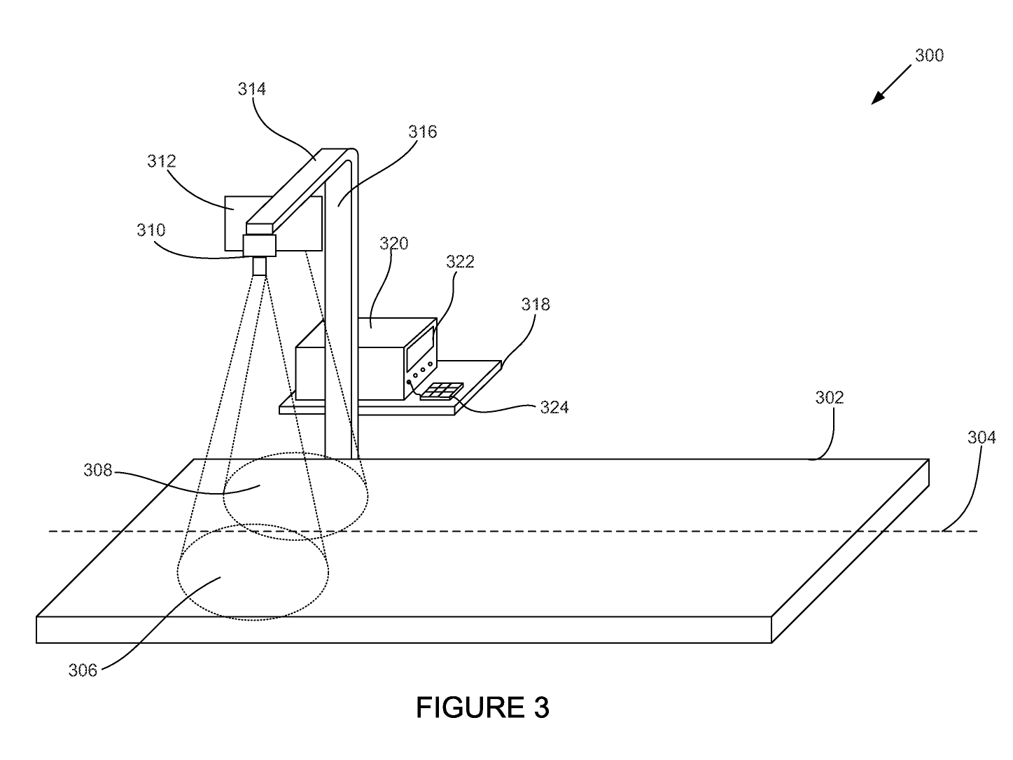

FIG. 3 illustrates an exemplary system in accordance with systems and methods for providing real-time surgery visualization to achieve symmetric results. System 300 includes surgical table 302. Surgical table 302 is configured to hold a subject during a surgical procedure. In one or more embodiments, the sagittal plane of the subject intersects a midline 304 of surgical table 302 when the subject is positioned on surgical table 302.

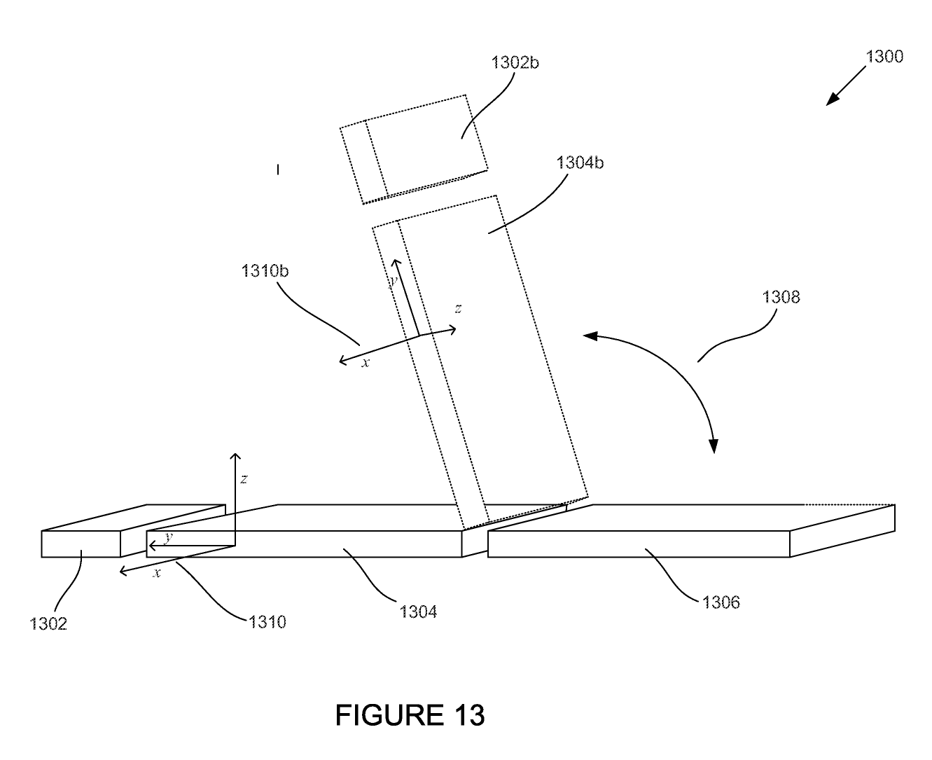

At least one section of surgical table 302 may be adjustable, such as the surgical table shown in FIG. 13. One or more components of system 300, such as one or more imaging devices and projectors, maybe configured to move with one or more adjustable sections of surgical table 302 to maintain a constant position relative to the area of the subject undergoing the surgical procedure.

System 300 further includes at least one three-dimensional imaging device 310. Three-dimensional imaging device 310 is configured to capture at least one dimensional image of a first area of the subject during a surgical procedure. Three-dimensional imaging device 310 may include a bicameral stereoscopic imaging device. In one or more embodiments, three-dimensional imaging device 310 is located and oriented to capture a three-dimensional image of the first area of the subject located in first region 306.

System 300 further includes at least one projector 312. Projector 312 is configured to project at least one reflected image onto a second area of the subject located across an axis of symmetry of the subject from the first area of the subject. In one or more embodiments, projector 312 is located and oriented to project a reflected image onto second region 308.

System 300 further includes computer 320. Computer 320 includes at least one processor and a computer readable-medium encoded with instructions. Computer 320 may also include at one or more displays 322 and one more input devices 324. Computer 320 may include one or more components described in system 100 of FIG. 1.

Computer 320 is configured to process the at least one three-dimensional image from imaging device 310 to obtain the at least one reflected image that is projected by projector 312.

In one or more embodiments, computer 320 is also configured to process and modify the reflected image to account for a non-flat projection surface of the second area of the subject to avoid distortion from projecting onto the non-flat surface.

Computer 320 may also be configured to use image processing to determine at least one enhancement and modify the reflected image to include the enhancement. Computer 320 may be configured to automatically perform image processing and other computation using one or more algorithms, heuristics, or any other computational method.

Computer 320 may be configured to control imaging device 310 and projector 312 through a direct connection, including a wired connection, a wireless connection, and network connection, or any other communication connection. Computer 400 may also be configured to control at least one of a location and an orientation of imaging device 310 and/or projector 312.

System 300 further includes at least one support 314-318. Imaging device 310, projecting device 312 and/or computer 320 may be coupled with supports 314-318. Any component of system 300 may be coupled detachably and/or adjustably with one or more supports 314-318. In one or more embodiments, a location and orientation of at least one of imaging device 310, projecting device 312, and supports 314-318 is adjustable.

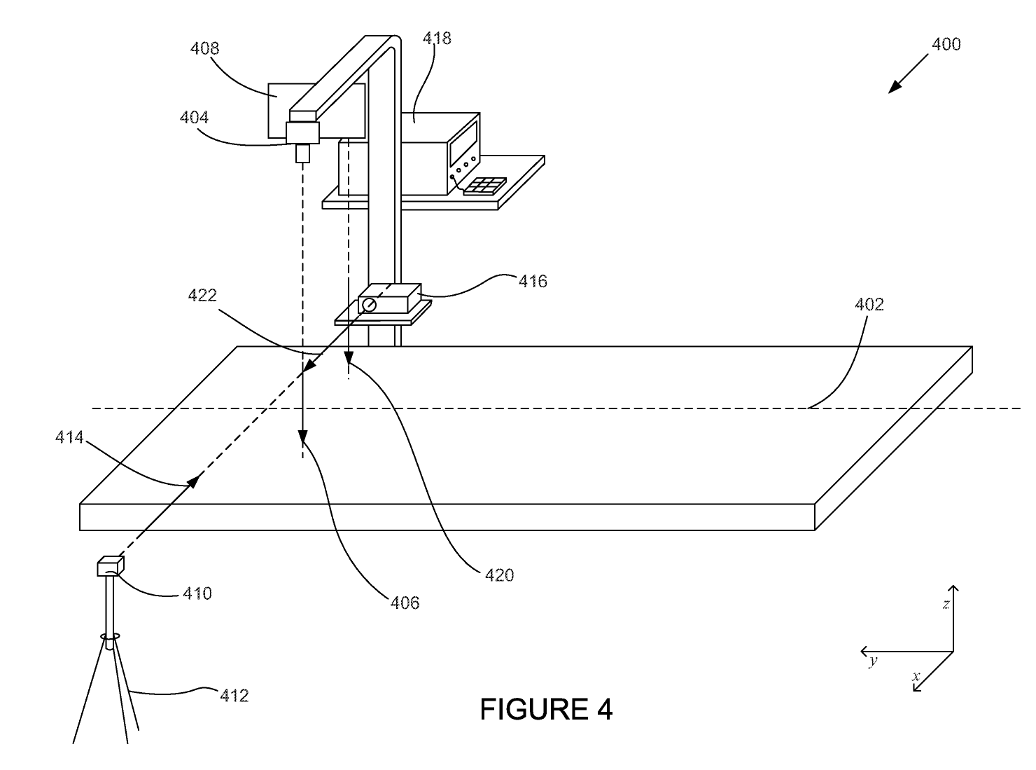

FIG. 4 illustrates an exemplary system in accordance with systems and methods for providing real-time surgery visualization to achieve symmetric results. System 400 includes surgical table 402. Surgical table 402 is configured to hold a subject during a surgical procedure. In one or more embodiments, the sagittal plane of the subject intersects a midline 404 of surgical table 402 when the subject is positioned on surgical table 402.

At least one section of surgical table 402 may be adjustable, such as the surgical table shown in FIG. 13. One or more components of system 400, such as one or more imaging devices and projectors, maybe configured to move with one or more adjustable sections of surgical table 402 to maintain a constant position relative to the area of the subject undergoing the surgical procedure.

System 400 includes YZ imaging device 410. YZ imaging device 410 is configured to capture a YZ image of a first area of a subject during a surgical procedure. YZ imaging device 410 is configured to face YZ capture orientation 414. YZ capture orientation 414 is approximately perpendicular to the YZ plane of the first area of the subject.

System 400 further includes YZ projector 416. YZ projector 416 is configured to project a reflected YZ image based on the YZ image of the first area of the subject. The reflected YZ image is projected onto a second area of the subject during the surgical procedure. YZ projector 416 is configured to face YZ projection orientation 422. YZ projection orientation 422 is approximately perpendicular to the YZ plane. In one or more embodiments, YZ capture orientation 414 is about 180° from YZ projection orientation 422.

In one or more embodiments, system 400 further includes XY imaging device 404. XY imaging device 404 is configured to capture an XY image of the first area of the subject during the surgical procedure. XY imaging device 404 is configured to face XY capture orientation 406. XY capture orientation 406 is approximately perpendicular to the XY plane of the first area of the subject.

In one or more embodiments, system 400 further includes XY projector 420. XY projector 420 is configured to project a reflected XY image based on the XY image of the first area of the subject. The reflected XY image is projected onto a second area of the subject during the surgical procedure. XY projector 408 is configured to face XY projection orientation 420. XY projection orientation 420 is approximately perpendicular to the XY plane. In one or more embodiments, XY capture orientation 406 is about parallel to XY projection orientation 420.

System 400 further includes computer 418. Computer 418 includes at least one processor and a computer readable-medium encoded with instructions. Computer 418 is configured to generate the reflected YZ image based on the YZ image of the first area of the subject, and to register the reflected YZ image with the second area of the subject.

In one or more embodiments, computer 418 is configured to generate the reflected XY image based on the XY image of the first area of the subject, and to register the XY image with the second area of the subject.

Computer 418 may also be configured to process the YZ reflected image to account for a non-flat projection surface of the second area of the subject.

In one or more embodiments, computer 418 is also configured to process the XY reflected image to account for a non-flat projection surface of the second area of the subject.

Computer 418 may also be configured to use image processing to determine at least one enhancement and modify at least one of the YZ reflected image and the XY reflected image to include the enhancement. Computer 418 may be configured to automatically perform image processing and other computation using one or more algorithms, heuristics, or any other computational method.

Computer 418 may be configured to control at least one of YZ imaging device, YZ projector, XY imaging device, and XY projector through a direct connection, including a wired connection, a wireless connection, and network connection, or any other communication connection. Computer 418 may also be configured to control at least one of a location and an orientation of YZ imaging device, YZ projector, XY imaging device and/or XY projector. One or more components of system 400 may be supported by at least one support, including one or more independent supports 412.

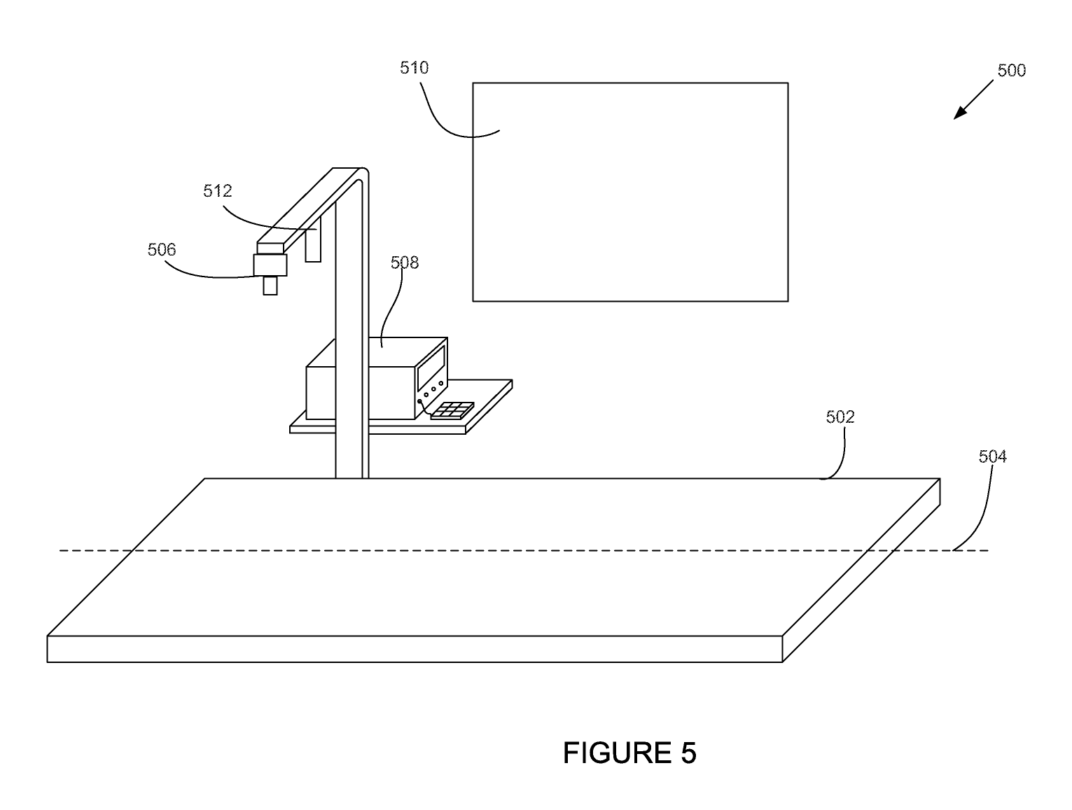

FIG. 5 illustrates an exemplary system in accordance with systems and methods for providing real-time surgery visualization to achieve symmetric results. System 500 includes surgical table 502. Surgical table 502 is configured to hold a subject during a surgical procedure. In one or more embodiments, the sagittal plane of the subject intersects a midline 504 of surgical table 502 when the subject is positioned on surgical table 502.

At least one section of surgical table 502 may be adjustable, such as the surgical table shown in FIG. 13. One or more components of system 500, such as one or more imaging devices and projectors, maybe configured to move with one or more adjustable sections of surgical table 502 to maintain a constant position relative to the area of the subject undergoing the surgical procedure.

System 500 further includes at least one three-dimensional imaging device 506. Three-dimensional imaging device 506 is configured to capture at least one three-dimensional image of a first area of the subject during a surgical procedure. Three-dimensional imaging device 506 may include a bicameral stereoscopic imaging device.

System 500 further includes at least one three-dimensional video capture device 512. Three-dimensional video capture device 512 is configured to capture a live video feed of the second area of the subject during the surgical procedure. The second area of the subject is positioned across an axis of symmetry of the subject with respect to the first area of the subject.

System 500 further includes display 510. Display 510 is configured to stereoscopic display an augmented video feed generated from the live video feed from three-dimensional video capture device 512 and data from the three-dimensional image from three-dimensional imaging device 506. In one or more embodiments, display 510 includes at least one projector and a projection surface. The at least one projector is configured to stereoscopically project video data.

System 500 further includes computer 508. Computer 508 includes at least one processor and a computer readable-medium encoded with instructions. Computer 508 is configured to process the at least one three-dimensional image from imaging device 506 to obtain the at least one reflected image. Computer 508 is further configured to generate an augmented video feed including the live video feed and data from the at least one reflected image. The augmented video feed may include the reflected image superimposed on the live video feed. In one or more embodiments, the augmented video feed includes the live video feed and one or more enhancements generated from the reflected image or the three-dimensional image. Computer 508 may also be configured to use image processing to determine at least one enhancement and modify the augmented video feed to include the enhancement.

Computer 508 may be configured to automatically perform image processing and other computation using one or more algorithms, heuristics, or any other computational method.

Computer 508 may be configured to control three-dimensional imaging device 506, three-dimensional video capture device 512 and/or one or more components of display 510 through a direct connection, including a wired connection, a wireless connection, and network connection, or any other communication connection.

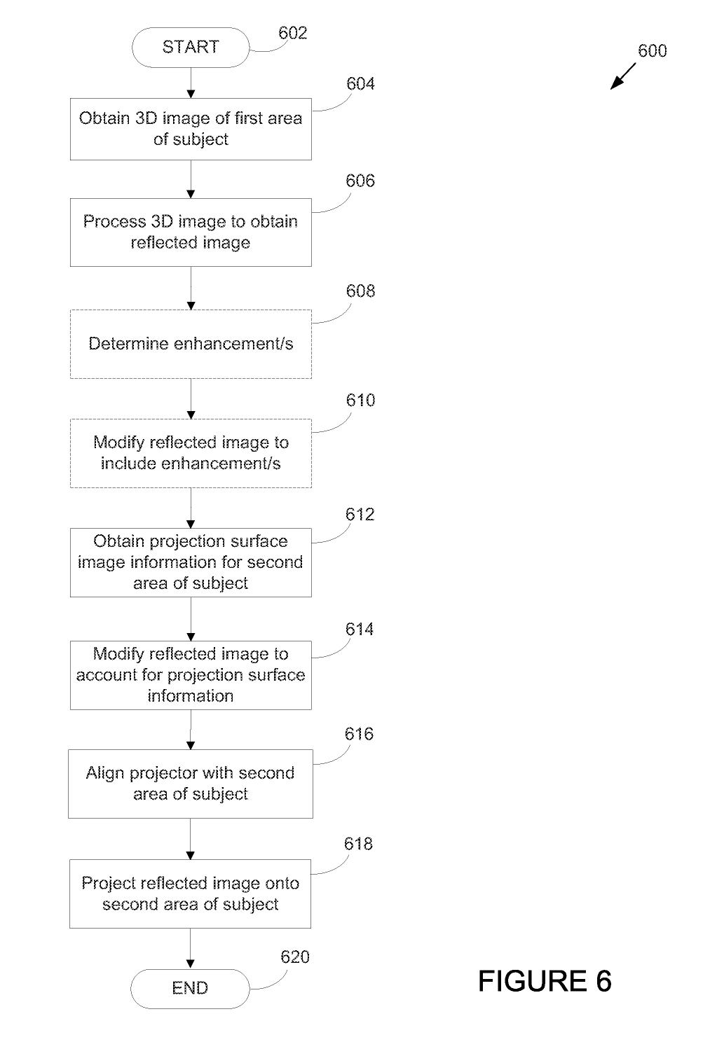

FIG. 6 illustrates an exemplary method in accordance with systems and methods for providing real-time surgery visualization to achieve symmetric results. Process 600 starts at step 602.

Processing continues to step 604, where at least one three-dimensional image of a first area of a subject is obtained. The at least one three-dimensional image is obtained during a surgical procedure from at least one three-dimensional imaging device. In one or more embodiments, the surgical procedure is a plastic surgery procedure. The surgical procedure may include at least one of a breast image enhancement procedure and a breast reconstruction procedure, where the first area is a first breast of the subject and the second area is a second breast of the subject. The at least one three-dimensional imaging device may include a bicameral stereoscopic imaging device that includes two cameras placed at a slight offset.

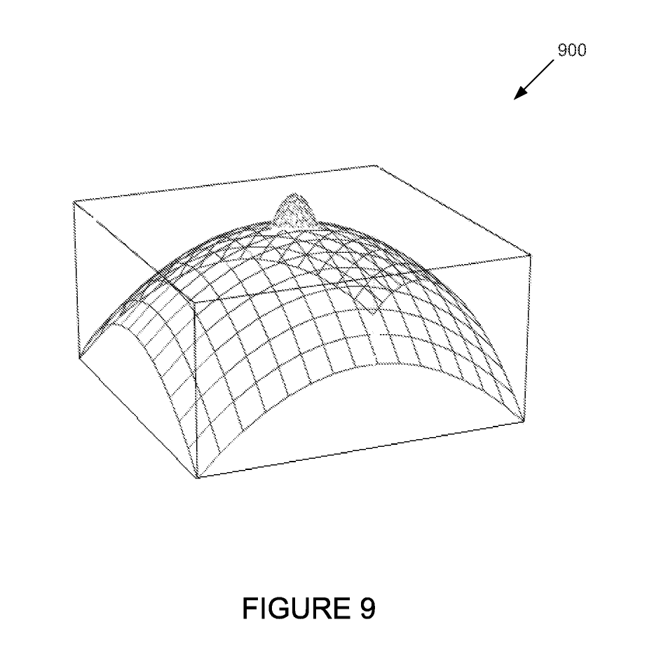

In one or more embodiments, the at least one three-dimensional imaging device is a first area scanner, and the at least one three-dimensional image is produced from three-dimensional surface information of the first area of the subject obtained using a first area scanner. FIG. 9 provides a more detailed explanation of three-dimensional surface information in accordance with systems and methods for providing real-time surgery visualization to achieve symmetric results.

Processing continues to step 606, where the least one three-dimensional image is processed to obtain at least one reflected image. The at least one reflected image is reflected with respect to the axis of symmetry. The at least one reflected image may be generated using optical components for generating a mirror image. The at least one reflected image may also be generated using one or more image processing algorithms, heuristics or other computational methods.

In one or more embodiments, the at least one three-dimensional image includes a plurality of three-dimensional images at multiple time points, including but not limited to a time lapse, a video, or any other plurality of images associated with multiple time points. In one or more embodiments, at least one updated reflected image is generated from at least one three-dimensional image obtained at the most recent of the multiple time points.

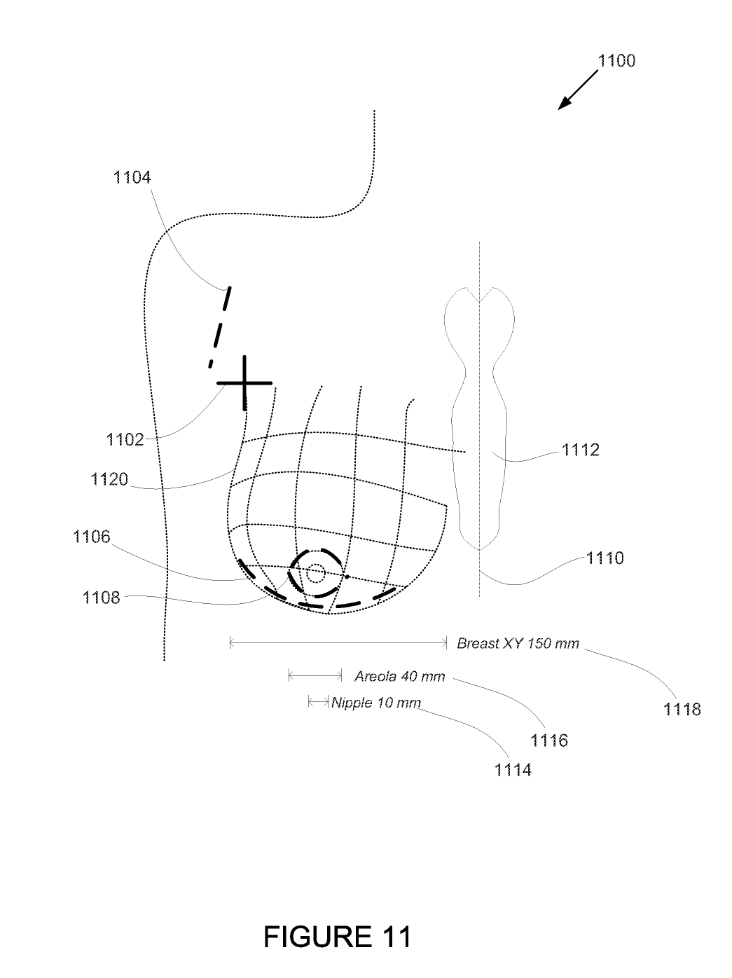

Processing continues to optional step 608, where at least one image enhancement is determined. The at least one image enhancement may be determined using one or more image processing algorithms, heuristics, or other computational methods. FIG. 11 provides a more detailed explanation of image enhancements in accordance with systems and methods for providing real-time surgery visualization to achieve symmetric results.

Processing continues to optional step 610, where the reflected image is modified to include the at least one image enhancement.

Processing continues to step 612, where projection surface information for a second area of the subject is obtained. The second area of the subject is located across an axis of symmetry from the first area of the subject. In one or more embodiments, the axis of symmetry is a bilateral axis of symmetry of the subject.

For example, projection surface information may be obtained using a second area scanner configured to obtain three dimensional surface information of the second area of the subject. The second area scanner may be used before the surgical procedure to generate the projection surface information. The second area scanner may also be used during the surgical procedure to generate the projection surface information and/or update the projection surface information when the second area of the subject is undergoing surgical modification.

FIG. 9 provides a more detailed explanation of projection surface information in accordance with systems and methods for providing real-time surgery visualization to achieve symmetric results.

One of ordinary skill in the art would appreciate that approximation of projection surface information for a specific body area may be sufficient for one or more embodiments of the system and method for providing real-time surgery visualization. For example, template surface information may be generated for a specific part of the human anatomy. One or more parameters may be automatically detected or manually modified to improve the approximation of the second area of the specific subject.

Processing continues to step 614, where the at least one reflected image is modified to account for the projection surface information. In one or more embodiments, the modification includes applying one or more image processing algorithms, heuristics, or other computational techniques to reduce or prevent distortion of an image projected onto a non-flat surface. Methods for reducing and preventing distortion when projecting an image onto a three-dimensional surface are known in the art, such as U.S. Pat. No. 5,325,473 to Monroe, filed Oct. 11, 1991, entitled “APPARATUS AND METHOD FOR PROJECTION UPON A THREE-DIMENSIONAL OBJECT”, which is hereby incorporated in its entirety.

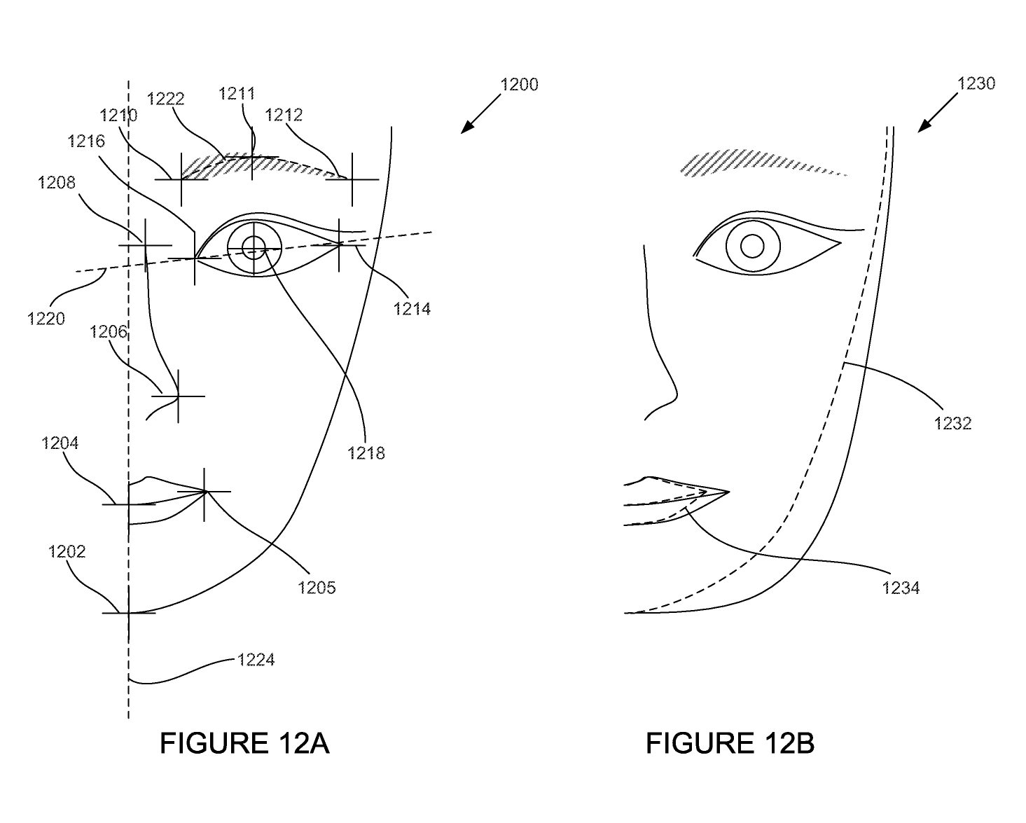

Processing continues to step 616, where a projector is aligned with the second area of the subject. In one or more embodiments, the alignment of the projector is based on the registration of the reflected image of the first area of the subject and the projection surface information of the second area of the subject. FIG. 12 provides a more detailed explanation of image registration in accordance with systems and methods for providing real-time surgery visualization to achieve symmetric results.

Processing continues to step 618, where the at least one reflected image is projected onto the second area of the subject. In one or more embodiments, additional three-dimensional images are obtained in real time during the surgical procedure, and at least one updated reflected image is generated and projected onto the second area of subject in real time in accordance with process steps 606-618.

Processing continues to step 620, where process 600 terminates.

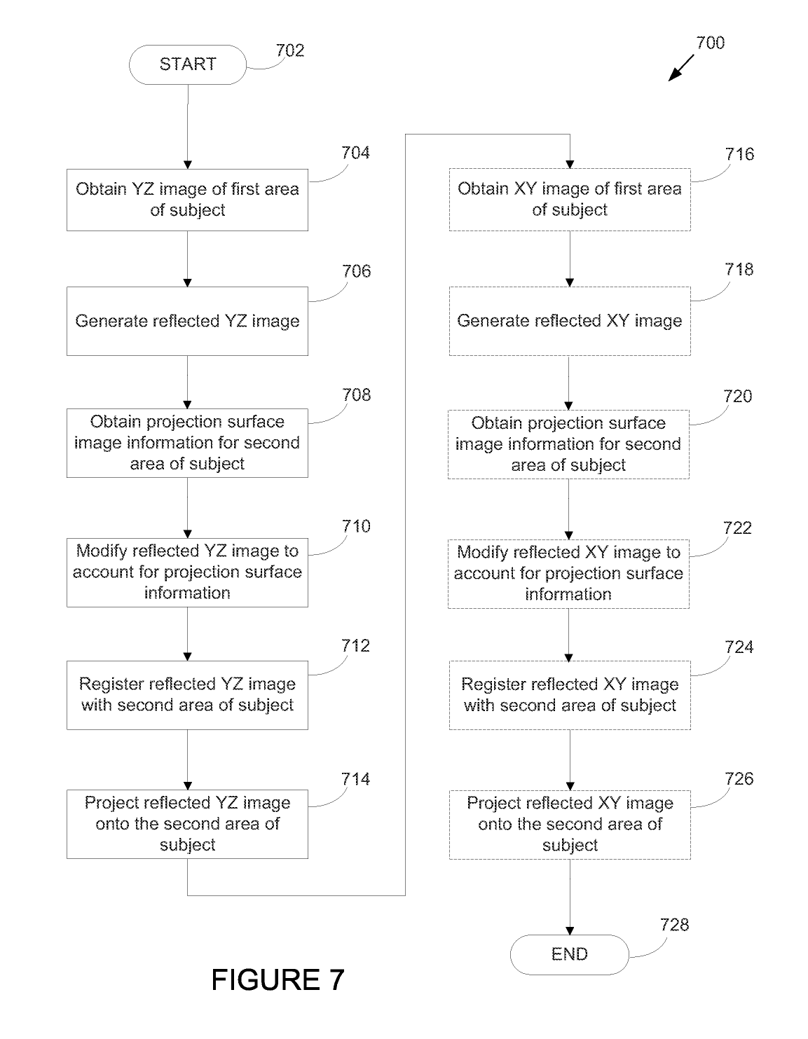

FIG. 7 illustrates an exemplary method in accordance with systems and methods for providing real-time surgery visualization to achieve symmetric results. Process 700 starts at step 702.

Processing continues to step 704, where a YZ image of a first area of a subject is obtained during a surgical procedure. In one or more embodiments, the surgical procedure is a plastic surgery procedure. The surgical procedure may include at least one of a breast image enhancement procedure and a breast reconstruction procedure, where the first area is a first breast of the subject and the second area is a second breast of the subject.

Processing continues to step 706, where a reflected YZ image is generated. The reflected YZ image may be generated using optical components for generating a mirror image. The reflected YZ image may also be generated using one or more image processing algorithms, heuristics or other computational methods.

Processing continues to step 708, where projection surface image information for a second area of the subject is obtained. The second area of the subject is located across an axis of symmetry from the first area of the subject. In one or more embodiments, the axis of symmetry is a bilateral axis of symmetry of the subject.

For example, projection surface information may be obtained using one or more second area scanners configured to obtain three dimensional surface information of the second area of the subject. The second area scanner may be used before the surgical procedure to generate the projection surface information. The second area scanner may also be used during the surgical procedure to generate the projection surface information and/or update the projection surface information when the second area of the subject is undergoing surgical modification.

FIG. 9 provides a more detailed explanation of projection surface information in accordance with systems and methods for providing real-time surgery visualization to achieve symmetric results.

In one or more embodiments, a YZ second area scanner positioned at or near the YZ projector is used to obtain accurate surface area information from the projection source.

One of ordinary skill in the art would appreciate that approximation of projection surface information for a specific body area may be sufficient for one or more embodiments of the system and method for providing real-time surgery visualization. For example, template surface information may be generated for a specific part of the human anatomy. The template surface information may include spatial three-dimensional surface information for the entire part of the human anatomy. The template surface information may alternatively include projection surface information from the perspective of the YZ projector. One or more parameters may be automatically detected or manually modified to improve the approximation of the second area of the specific subject.

Processing continues to step 710, where the reflected YZ image is modified to account for the projection surface information. In one or more embodiments, the modification includes applying one or more algorithms to reduce or prevent distortion of an image projected onto a non-flat surface.

Processing continues to step 712, where the reflected YZ image is registered with the second area of the subject. FIG. 12 provides a more detailed explanation of image registration in accordance with systems and methods for providing real-time surgery visualization to achieve symmetric results.

Processing continues to step 714, where the reflected YZ image is projected onto the second area of the subject.

In one or more embodiments, at least one updated YZ image is obtained at a time point during the surgical procedure. An updated reflected YZ image is generated from the updated YZ image and projected onto the second area of the subject in accordance with steps 704-714.

Processing continues to optional step 716, where an XY image of the first area of the subject is obtained during a surgical procedure. In one or more embodiments, the surgical procedure is a plastic surgery procedure. The surgical procedure may include at least one of a breast image enhancement procedure and a breast reconstruction procedure, where the first area is a first breast of the subject and the second area is a second breast of the subject.

Processing continues to optional step 718, where a reflected XY image is generated. The reflected YZ image may be generated using optical components for generating a mirror image. The reflected YZ image may also be generated using one or more image processing algorithms, heuristics or other computational methods.

Processing continues to optional step 720, where projection surface information for the second area of the subject is obtained. The second area of the subject is located across an axis of symmetry from the first area of the subject. In one or more embodiments, the axis of symmetry is a bilateral axis of symmetry of the subject.

For example, projection surface information may be obtained using one or more second area scanners configured to obtain three dimensional surface information of the second area of the subject. The second area scanner may be used before the surgical procedure to generate the projection surface information. The second area scanner may also be used during the surgical procedure to generate the projection surface information and/or update the projection surface information when the second area of the subject is undergoing surgical modification.

FIG. 9 provides a more detailed explanation of projection surface information in accordance with systems and methods for providing real-time surgery visualization to achieve symmetric results.

In one or more embodiments, an XY second area scanner positioned at or near the YZ projector is used to obtain accurate surface area information from the projection source.

One of ordinary skill in the art would appreciate that approximation of projection surface information for a specific body area may be sufficient for one or more embodiments of the system and method for providing real-time surgery visualization. For example, template surface information may be generated for a specific part of the human anatomy. The template surface information may include spatial three-dimensional surface information for the entire part of the human anatomy. The template surface information may alternatively include projection surface information from the perspective of the XY projector. One or more parameters may be automatically detected or manually modified to improve the approximation of the second area of the specific subject.

Processing continues to optional step 722, where the reflected XY image is modified to account for the projection surface information. In one or more embodiments, the modification includes applying one or more algorithms to reduce or prevent distortion of an image projected onto a non-flat surface.

Processing continues to optional step 724, where the reflected XY image is registered with the second area of the subject. FIG. 12 provides a more detailed explanation of image registration in accordance with systems and methods for providing real-time surgery visualization to achieve symmetric results.

Processing continues to optional step 726, where the reflected XY image is projected onto the second area of the subject.

In one or more embodiments, at least one updated XY image is obtained at a time point during the surgical procedure. An updated reflected XY image is generated from the updated XY image and projected onto the second area of the subject in accordance with steps 716-726.

An updated XY image or an updated YZ image may be obtained at any time during the surgical procedure and the reflected XY image and reflected YZ image projected onto the second area of the subject may be updated in real time. The updated XY image and/or updated YZ image may be obtained separately or at the same time during the surgical procedure. An update may be made at a regular interval, or at any time point during the surgical procedure based on user input. In order more embodiments, at least one of the XY image and the YZ image is obtained as a continuous video feed, and at least one of the reflected XY image and the reflected YZ image is projected as a continuous projected video feed onto the second area of the subject.

Processing continues to step 728, where process 700 terminates.

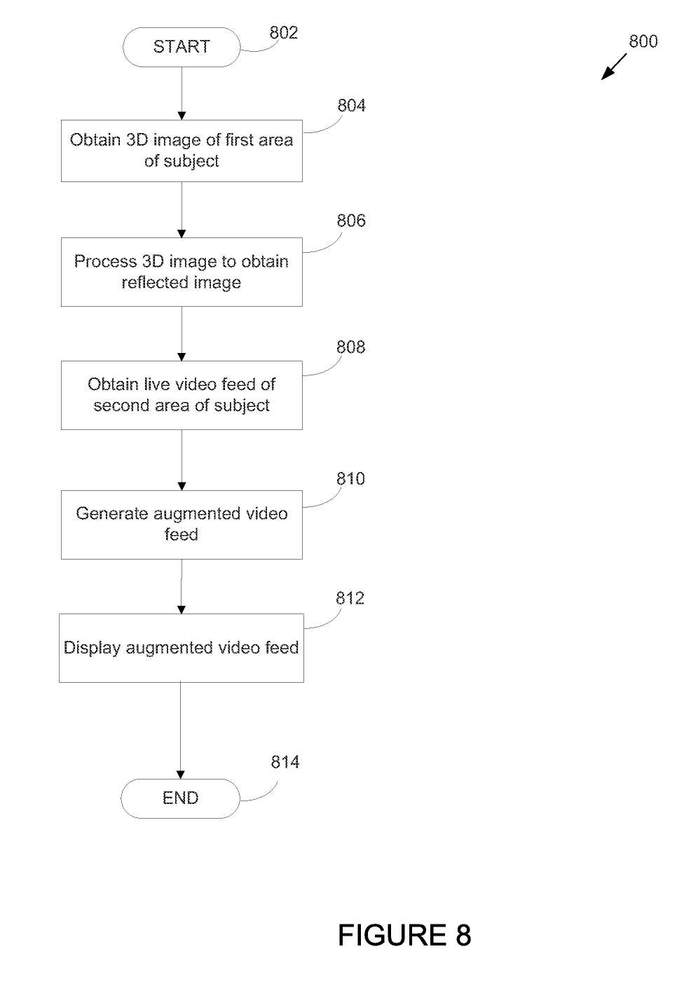

FIG. 8 illustrates an exemplary method in accordance with systems and methods for providing real-time surgery visualization to achieve symmetric results. Process 800 starts at step 802.

Processing continues to step 804, where a three-dimensional image of a first area of a subject is obtained during a surgical procedure. In one or more embodiments, the surgical procedure is a plastic surgery procedure. The surgical procedure may include at least one of a breast image enhancement procedure and a breast reconstruction procedure, where the first area is a first breast of the subject and the second area is a second breast of the subject. The at least one three-dimensional imaging device may include a bicameral stereoscopic imaging device that includes two cameras placed at a slight offset.

Processing continues to step 806, where the three-dimensional image is processed to obtain a reflected image. The at least one reflected image is reflected with respect to an axis of symmetry. The at least one reflected image may be generated using optical components for generating a mirror image. The at least one reflected image may also be generated using one or more image processing algorithms, heuristics or other computational methods.

Processing continues to step 808, where a live video feed of a second area of the subject is obtained. The second area of the subject is located across an axis of symmetry from the first area of the subject. In one or more embodiments, the axis of symmetry is a bilateral axis of symmetry of the subject.

Processing continues to step 810, where an augmented video feed is generated. The augmented video feed includes the live video feed and data from the reflected image. In one or more embodiments, the augmented video feed includes the reflected image superimposed on the augmented video feed. Alternatively, the augmented video feed is modified to include select features of the reflected image, one or more features, such as image enhancements. FIG. 11 provides a more detailed explanation of image enhancements in accordance with systems and methods for providing real-time surgery visualization to achieve symmetric results.

Processing continues at step 812, where the augmented video feed is displayed. In one or more embodiments, the augmented video feed to stereoscopic reviewable by at least one participant of the surgery in real time. In one or more embodiments, at least one projector is configured to stereoscopically project the augmented video feed onto a projection surface.

Processing continues to step 814, where process 800 terminates.

Additional three-dimensional images of the first area of the subject may be obtained in real time during the surgical procedure. The augmented video feed is updated based on the additional three-dimensional images.

In one or more embodiments, a first area video stream of the first area of the subject is obtained, and the augmented video feed is continuously updated to reflect both the live video feed of the second area and the first area video stream.

FIG. 9 illustrates three-dimensional surface information in accordance with systems and methods for providing real-time surgery visualization to achieve symmetric results.

In one or more embodiments, a first area scanner serves as the imaging device to obtain a three-dimensional image of the first area of the subject. The first area scanner may be used in real-time during the surgical procedure. Three-dimensional surface information 900 may be obtained from a first area scanner configured to obtain three-dimensional surface information of a first area of a subject. The three-dimensional image of the first area of the subject is produced using the three-dimensional surface information, such as by using one or more and image processing algorithms, heuristics, or other computational methods.

In one or more embodiments, projection surface information 900 of the second area of the subject is obtained. Projection surface information 900 may be obtained in real-time during the surgical procedure. Projection surface information 900 may be used to register a reflected image of the first area with a second area of the subject. Projection surface information 900 may also be used to modify the reflected image of the first area to reduce or prevent distortion of an image projected onto a non-flat surface, such as the second area of the subject.

In one or more embodiments, non-contact active technology is used to obtain three-dimensional surface information. A non-contact active three-dimensional scanner uses a radiation source and a sensor to detect three-dimensional surface information. In one or more embodiments, at least one radiation source and/or at least one sensor is located at or near a projector and is oriented approximately in the same direction as the projector. One of ordinary skill in the art would recognize that any three-dimensional surface scanner may be used to obtain first area surface information and second area surface information without departing from the spirit and the scope of the invention.

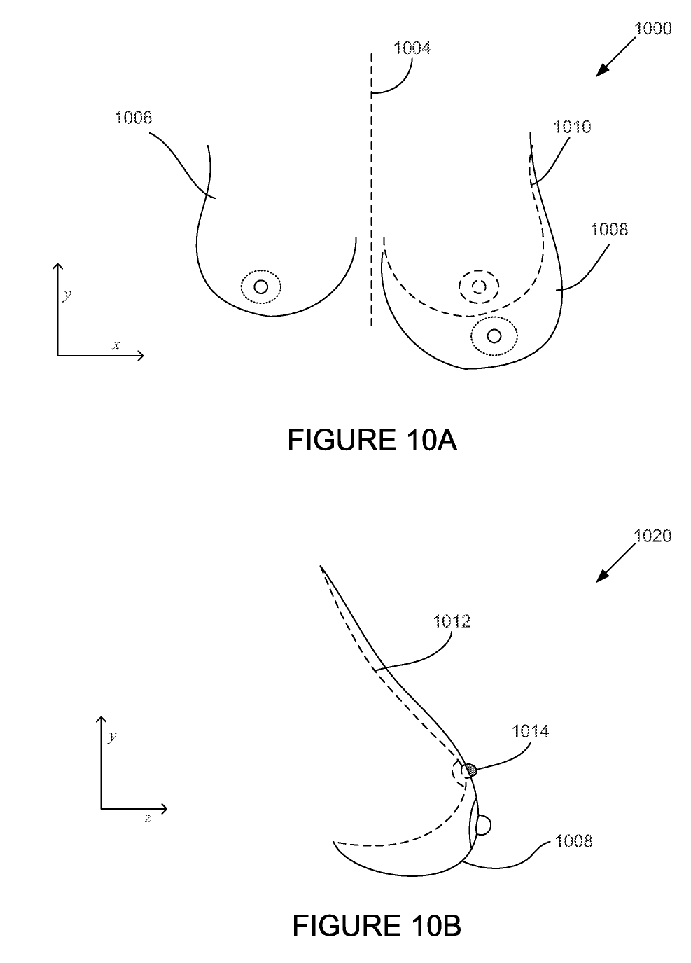

FIGS. 10A-10B illustrate an exemplary XY projection and YZ projection in accordance with systems and methods for providing real-time surgery visualization to achieve symmetric results. XY view 1000 is a front view of the subject. FIG. 10A shows a front view of the subject. Reflected XY image 1010 of a first area of the subject 1006 is projected onto the second area of the subject 1008 during a surgical procedure. Reflected XY image 1010 may be modified to reduce or prevent distortion of an image projected onto a non-flat surface.

FIG. 10B shows a side view of a second area of the subject. Reflected YZ image 1012 of the first area of the subject 1006 is projected onto the second area of the subject 1008 during a surgical procedure. Reflected YZ image 1010 may be modified to reduce or prevent distortion of an image projected onto a non-flat surface.

One or more non-overlapping features 1014 of the reflected XY image or the reflected YZ image may be present. In this case, non-overlapping features 1014 will lack a projection surface on the second area of the subject 1008. As the second area of the subject 1008 is modified during the surgical procedure, the amount and size of non-overlapping features 1014 may be reduced or eliminated.

FIG. 11 illustrates exemplary image enhancements in accordance with systems and methods for providing real-time surgery visualization to achieve symmetric results. Image 1100 is an image of the subject including a plurality of image enhancements 1102-1120. One or more image enhancements 1102-1120 are optionally added to either an image of the subject or a reflected image of the subject. The image enhancements may be manually selected from a set of potential image enhancements, manually input by a doctor or another operator before or during the surgical procedure, or automatically selected based on one or more image processing algorithms, heuristics, or other computational techniques. The image enhancements may also be modified to tailor the image enhancements to the subject and/or the surgical procedure.

Exemplary image enhancements shown in FIG. 11 include one or more markers 1102 indicating one or more anatomical features relevant to the surgical procedure. Although marker 1102 is shown as a point, marker 1102 may also include any shape, line, curve, or any other feature added to image 1100.

The image enhancements may also include one or more features related to the surgical procedure, such as transaxiliary incision 1104, periareolar incision 1106 and inframammary incision 1108, and any other feature related to the surgical procedure.

The image enhancements may also include one or more lines, curves and grids. For example, image enhancement 1110 indicates the axis of symmetry, and grid 1120 includes a plurality of curves indicating a curvature of the surface. The image enhancements may also include one or more internal structures 1112, such as bone, vessels, nerves, muscles, tendons, ligaments, or any other internal structure which are potentially relevant to achieving a asymmetric result of the surgical procedure.

The image enhancements may also include additional data 1114-1118, such as text, measurements, or any other additional data. For example, additional data 1114-1118 may include average measurements, pre-surgical measurements, target post-surgical measurements, or any other measurement. Additional data 1114-1118 may be manually selected from a set of potential image enhancements, manually input by a doctor or another operator before or during the surgical procedure, or automatically selected, calculated and/or approximated based on one or more image processing algorithms, heuristics, or other computational techniques. Additional data 1114-1118 may also be modified to tailor the additional data to the subject and/or the surgical procedure.

FIGS. 12A-B illustrate exemplary registration of a reflected image and a second area of a subject in accordance with systems and methods for providing real-time surgery visualization to achieve symmetric results. Reflected image 1200 is a reflected image of a first area of a subject. In one or more embodiments, at least one alignment feature common to the first area of the subject and the second area the subject is selected. An alignment feature may include one or more anatomical features common to the first area of the subject and the second area of the subject. The alignment features may be manually selected from a set of potential alignment features, manually input by a doctor or another operator before or during the surgical procedure, or automatically selected based on one or more image processing algorithms, heuristics, or other computational techniques.

At least one first area image feature 1202-1224 corresponding to the at least one alignment feature is determined. First area image features 1202-1224 may be manually selected from a set of potential alignment features, manually input on an image by a doctor or another operator before or during the surgical procedure, or automatically selected based on one or more image processing algorithms, heuristics, or other computational techniques. First area image features 1202-1224 may also be adjusted before or during the surgical procedure. One of ordinary skill in the art would appreciate that the at least one first area image feature 1202-1224 may be determined in either the image of the first area or the reflected image of the first area without departing from the spirit or scope of the invention.

The at least one first area image feature 1202-1224 may include one or more points, including start and end points of anatomical features, center points of anatomical features, maximum or minimum points of curves associated with anatomical features, points which intersect with a line such as an axis of symmetry 1224, or any other point usable to register a reflected image of the first area of the subject and the second area of the subject. The at least one first area image feature 1202-1224 may also include one or more lines and curves associated with anatomical features. For example, line 1220 approximates an orientation of an eye in reflected image 1200, curve 1222 approximates the location of an eyebrow in reflected image 1200, and line 1224 approximates the axis of symmetry. In one or more embodiments, an approximated outline of an anatomical feature in an image or reflected image of the first area of the subject is usable as a first area image feature.

FIG. 12B illustrates the second area 1230 of the subject registered with a reflected image 1232 of the first area of the subject. The reflected image of the first area the subject and the second area of the subject are registered based on at least one alignment feature. One or more image processing algorithms, heuristics, or other computational techniques for image registration may be used to register the at least one reflected image in the second area of the subject. In one or more embodiments, one or more projecting devices are configured to adjust the projected reflected image.

In one or more embodiments, at least one second area surface feature corresponding to at least one alignment feature is determined. For example, at least one second area surface feature may be determined based on projection surface information of the second area of the subject. At least one second area surface feature may also be determined based on one or more images of the second area of the subject.

In one or more embodiments, one or more excluded alignment features are excluded from the registration. The excluded alignment features may be manually selected from a set of potential alignment features, manually excluded by a doctor or another operator before or during the surgical procedure, or automatically excluded based on one or more image processing algorithms, heuristics, or other computational techniques. In one or more embodiments, one or more alignment features are excluded based on the type of surgical procedure when an expected asymmetry 1234 involving the excluded alignment feature will be present during at least one point of the surgical procedure.

FIG. 13 illustrates an adjustable surgical table in accordance with systems and methods for providing real-time surgery visualization to achieve symmetric results. Adjustable surgical table 1300 includes at least one section 1302-1306. A position and/or an orientation of at least one of sections 1302-1306 is adjustable. In one or more embodiments, an angle 1308 between two of sections 1302-1306 is adjustable. One or more hinges, screws, pins, locks, rods, motors, or any other mechanism may be used to provide manual or electronic adjustment of a position and/or orientation of one or more sections 1302-1306.

In one or more embodiments, adjustable surgical table 1300 is configured to move between a lying position and a seated position with respect to a subject. An angle 1308 between one or more upper sections 1302-1304 and one or more lower sections 1306 is adjustable.

In one or more embodiments, adjustable surgical table 1300 is configurable to position the subject in any position between a flat lying position and a vertical seated position. When angle 1308 is adjusted, the subject's torso is moved between a lying position and a seated position, and upper sections 1302-1304 are repositioned, as shown by moved upper sections 1302b and 1304b.

A first XYZ space 1310 includes an XY plane parallel to a top surface of sections 1302-1304 in the first position. A second XYZ space 1310b includes an XY plane parallel to the top surface of sections 1302b-1304b in the second position. In one or more embodiments, at least one imaging device and at least one projecting device are repositioned along with upper sections 1302-1304 such that a capture orientation of the imaging device and a projection orientation of the projecting device remain constant with respect to upper sections 1302-1304. The at least one imaging device and the at least one projecting device are positioned in approximately the same location and orientation with respect to the first XYZ space 1310 in the first position and the second XYZ space 1310b in the second position.

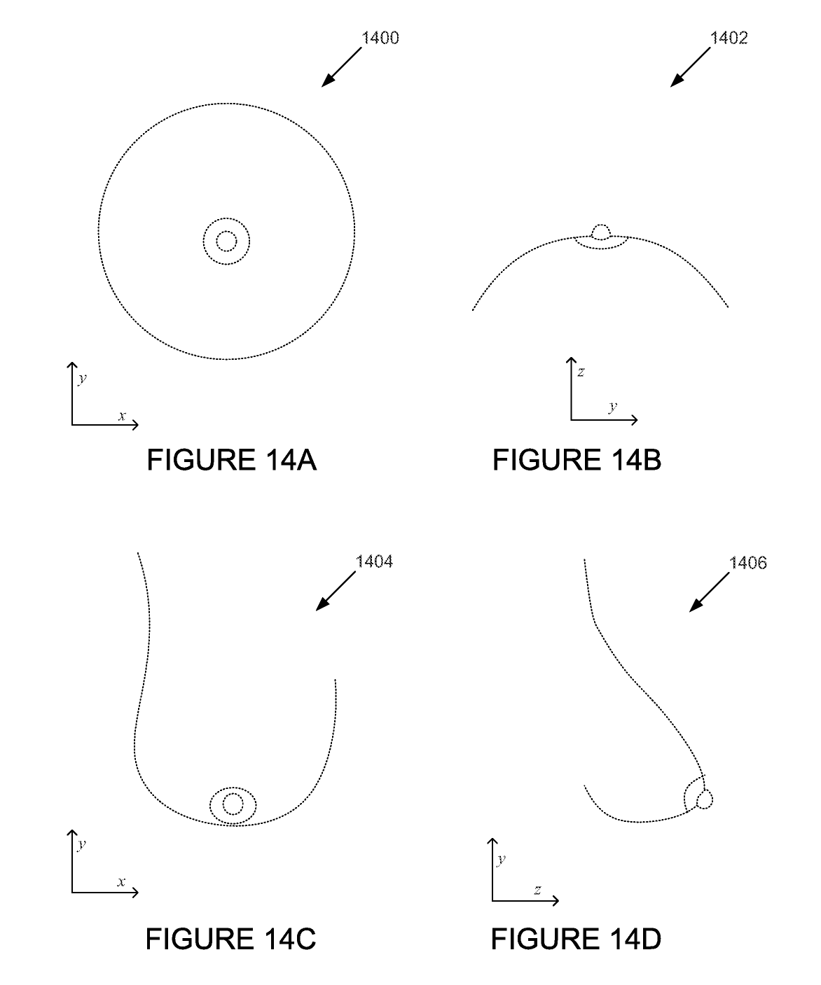

FIGS. 14A-D illustrate front and side views of an area of a subject lying on an adjustable surgical table in different positions in accordance with systems and methods for providing real-time surgery visualization to achieve symmetric results. During a surgical procedure, a subject may be moved between a first position, such as a lying position, and a second position, such as a seated position. An updated reflected image of the subject may be obtained in real time during the surgical procedure and projected onto the second area of the subject to achieve symmetric results between the first area of the subject of the second area of the subject. One of ordinary skill in the art would appreciate that more than two positions may be used in accordance with systems and methods for providing real-time surgery visualization to achieve symmetric results without departing from the spirit and scope of the invention.

In one or more embodiments, the first area of the subject and the second area of the subject are breasts, and the first position and the second position are selected to achieve symmetric results of the natural position and movement of the breast tissue after surgery. FIG. 14A shows a front view 1400 of a breast of a subject in an XY plane when the subject is in a lying position. FIG. 14B shows a side view 1402 of the breast of the subject in a YZ plane when the subject is in a lying position. FIG. 14C shows a front view 1404 of the breast of the subject in an XY plane when the subject is in a seated position. FIG. 14D shows a side view 1406 of the breast of the subject in a YZ plane when the subject is in a seated position.

While the invention herein disclosed has been described by means of specific embodiments and applications thereof, numerous modifications and variations could be made thereto by those skilled in the art without departing from the scope of the invention set forth in the claims.

What is claimed is:

1. A system for providing real-time surgery visualization to achieve symmetric results, the system comprising:
at least one three-dimensional imaging device configured to capture at least one three-dimensional image of a first area of a subject during a surgical procedure;
at least one projector configured to project at least one reflected image onto a second area of the subject located across an axis of symmetry of the subject from the first area of the subject, wherein the at least one reflected image is reflected with respect to the axis of symmetry and the first area of the subject; and
a computer comprising at least one processor and a computer-readable medium encoded with instructions, wherein execution of the instructions causes the at least one processor to execute process steps comprising:
processing the at least one three-dimensional image to obtain the at least one reflected image.

2. The system of claim 1, wherein the at least one three-dimensional imaging device comprises a bicameral stereoscopic imaging device.

3. The system of claim 1, wherein the at least one three-dimensional imaging device comprises a first area scanner configured to obtain three-dimensional surface information of the first area of the subject,
execution of the instructions causes the at least one processor to execute process steps further comprising producing the at least one three-dimensional image from the three-dimensional surface information.

4. The system of claim 1, further comprising a second area scanner configured to obtain projection surface information of the second area of the subject in three dimensions,
execution of the instructions causes the at least one processor to execute process steps further comprising processing the at least one reflected image to modify the at least one reflected image to account for the projection surface information before projection onto the second area of the subject.

5. The system of claim 1, wherein execution of the instructions causes the at least one processor to execute process steps further comprising:
using image processing to determine at least one image enhancement; and
modifying the at least one reflected image to include the at least one image enhancement.

6. The system of claim 1, wherein the axis of symmetry is a bilateral axis of symmetry of the subject.

7. The system of claim 1, wherein the at least one three-dimensional image comprises a plurality of three-dimensional images at multiple time points, wherein the at least one reflected image is projected in real-time by projecting at least one updated reflected image using the projector at the multiple time points.

8. The system of claim 1, wherein execution of the instructions causes the at least one processor to execute process steps further comprising:
obtaining projection surface information of the second area of the subject;
selecting at least one alignment feature common to the first area of the subject and the second area of the subject;
determining at least one first area image feature corresponding to the at least one alignment feature in the at least one three-dimensional image of the first area of the subject;
determining at least one second area surface feature corresponding to the at least one alignment feature in the second area of the subject using the projection surface information of the second area of the subject; and
registering the at least one reflected image and the second area of the subject based on the at least one first area image feature and the at least one second area surface feature.

9. The system of claim 1, wherein the surgical procedure is a plastic surgery procedure.

10. The system of claim 1, wherein the surgical procedure comprises at least one of a breast image enhancement procedure and a breast reconstruction procedure, wherein the first area is a first breast of the subject and the second area is a second breast of the subject.

11. A system for providing real-time surgery visualization to achieve symmetric results, the system comprising:
a YZ imaging device configured to capture a YZ image of a first area of a subject during a surgical procedure, wherein the YZ imaging device is configured to face a YZ capture orientation approximately perpendicular to a YZ plane of the first area of the subject;
a YZ projecting device configured to project a reflected YZ image of the subject onto a second area of the subject during the surgical procedure, wherein the YZ projecting device is configured to face a YZ projection orientation approximately perpendicular to the YZ plane, wherein the YZ capture orientation is about 180 degrees from the YZ projection orientation; and
a computer comprising one or more processors and a computer-readable medium encoded with instructions, wherein execution of the instructions causes the one or more processors to execute process steps comprising:
generating the reflected YZ image based on the YZ image; and
registering the reflected YZ image with the second area of the subject, wherein the second area of the subject is located across an axis of symmetry of the subject from the first area of the subject.

12. The system of claim 11, wherein the axis of symmetry is a bilateral axis of symmetry of the subject.

13. The system of claim 11, wherein execution of the instructions causes the at least one processor to execute process steps further comprising:
using image processing to determine at least one image enhancement; and
modifying the reflected YZ image to include at the least one image enhancement.

14. The system of claim 11, further comprising:
an XY imaging device configured to capture an XY image of the first area of the subject during the surgical procedure, wherein the XY imaging device is configured to face an XY capture orientation approximately perpendicular to an XY plane of the first area of the subject; and
an XY projecting device configured to project a reflected XY image of the subject onto the second area of the subject during the surgical procedure, wherein the XY projecting device is configured to face an XY projection orientation approximately perpendicular to the XY plane, wherein the XY capture orientation is about parallel to the XY projection orientation;
wherein execution of the instructions causes the at least one processor to execute process steps further comprising:
generating the reflected XY image based on the XY image; and
registering the reflected XY image with the second area of the subject.

15. The system of claim 11, wherein execution of the instructions causes the at least one processor to execute process steps further comprising:
obtaining a scan of the second area of the subject comprising projection surface information for the second area of the subject in three dimensions; and
processing the reflected YZ image to modify the reflected YZ image before projection onto the second area to account for the projection surface information.

16. The system of claim 11, wherein the surgical procedure is a plastic surgery procedure.

17. The system of claim 11, wherein the surgical procedure comprises at least one of a breast image enhancement procedure and a breast reconstruction procedure, wherein the first area is a first breast of the subject and the second area is a second breast of the subject.

18. A system for providing real-time surgery visualization to achieve symmetric results, the system comprising:
at least one three-dimensional imaging device configured to capture at least one three-dimensional image of a first area of a subject during a surgical procedure;
a display configured to display three-dimensional video; and
at least one three-dimensional video capture device configured to capture a live video feed of a second area of the subject during the surgical procedure, wherein the second area of the subject is positioned across an axis of symmetry of the subject with respect to the first area of the subject;
a computer comprising at least one processor and a computer-readable medium encoded with instructions, wherein execution of the instructions causes the at least one processor to execute process steps comprising:
processing the at least one three-dimensional image to obtain at least one reflected image of the at least one three-dimensional image, wherein the at least one reflected image is reflected with respect to the axis of symmetry and the first area of the subject;
generating an augmented video feed comprising the live video feed and data from the at least one reflected image; and
displaying the augmented video feed on the display, wherein the augmented video feed is stereoscopically viewable by at least one participant of the surgery in real time.

19. The system of claim 18, wherein the display comprises at least one projector and a projection surface, wherein the at least one projector is configured to stereoscopically project the augmented video feed onto the projection surface.

20. The system of claim 18, wherein the three-dimensional imaging device comprises a three-dimensional optical scanner configured to obtain three-dimensional surface information of the first area of the subject, wherein execution of the instructions causes the at least one processor to execute process steps further comprising producing the at least one three-dimensional image from the three-dimensional surface information.

21. The system of claim 18, wherein execution of the instructions causes the at least one processor to execute process steps further comprising:
using image processing to determine at least one image enhancement; and
modifying the augmented video feed to include the at least one image enhancement.

22. The system of claim 18, wherein the axis of symmetry is a bilateral axis of symmetry of the subject.

23. The system of claim 18, wherein the at least one three-dimensional image comprises a plurality of three-dimensional images at multiple time points, wherein execution of the instructions causes the at least one processor to execute process steps further comprising updating the augmented video feed based on at least one most recent three-dimensional image.

24. The system of claim 18, wherein execution of the instructions causes the at least one processor to execute process steps further comprising:
selecting at least one alignment feature common to the first area of the subject and the second area of the subject;
determining at least one first area image feature corresponding to the at least one alignment feature in the at least one three-dimensional image of the first area of the subject; and
determining at least one second area surface feature corresponding to the at least one alignment feature in the live video feed,
wherein generating the augmented video feed comprises registering the at least one reflected image and the live video feed based on the at least one first area image feature and the at least one second area surface feature.

25. The system of claim 18, wherein the surgical procedure is a plastic surgery procedure.

26. The system of claim 18, wherein the surgical procedure comprises at least one of a breast image enhancement procedure and a breast reconstruction procedure, wherein the first area is a first breast of the subject and the second area is a second breast of the subject.
